(19) United States
(12) Patent Application Publication
(10) Pub. No.: US 2012/0067499 A1
(43) Pub. Date: Mar. 22, 2012

(54) FIXING OF VACUUM INSULATION PANELS IN COOLING APPARATUSES

(75) Inventors: Mark ELBING, Bremen (DE); Markus Schütte, Osnabrueck (DE); Jörg Krogmann, Lohne (DE); Johann Klassen, Stemwede-Oppendorf (DE); Jürgen Boos, Nordhorn (DE)

(73) Assignee: BASF SE, Ludwigshafen (DE)

(21) Appl. No.: 13/235,716

(22) Filed: Sep. 19, 2011

Related U.S. Application Data
(60) Provisional application No. 61/385,162, filed on Sep. 22, 2010.

(51) Int. Cl. B32B 37/14; B32B 37/02; C08L 75/04

(52) U.S. Cl. 156/60; 521/170

(57) ABSTRACT

A polyurethane foam reaction system to fix over an area of a vacuum insulation panel (VIP) on an inside of an outer wall of a cooling apparatus and/or on a outside of a wall of a inner container of the cooling apparatus, where the reaction system includes the following components: an organic and/or a modified organic polyisocyanate; at least one high molecular weight compound having at least two hydrogen atoms which are reactive toward a isocyanate group; a blowing agent; a catalyst; and a foam stabilizer, where the components are selected to obtain a closed-cell polyurethane foam having a free-foamed density of 50 to 1100 g/l and a compressive strength of ≧15 kPa, excluding rigid integral foams.

The invention relates to the use of a specific polyurethane (PUR) foam reaction system for the fixing over an area of vacuum insulation panels (VIPs) on a wall of a cooling apparatus and also a process for producing composites which comprise a wall of a cooling apparatus, a PUR foam layer and at least one VIP.

Vacuum insulation units, also referred to as vacuum insulation panels, are being increasingly used for thermal insulation. They are employed, inter alia, for refrigeration appliance housings, containers for refrigerated vehicles, coolboxes, cooling cells or district heating pipes. Owing to their low thermal conductivity, they offer advantages over conventional insulation materials. Thus, the energy saving potential compared to closed-celled rigid polyurethane foams is usually from about 20 to 30%.

Such vacuum insulation units generally comprise a thermally insulating core material, for example open-celled rigid polyurethane (PUR) foam, open-celled extruded polystyrene foam, silica gels, glass fibers, beds of loose polymer particles, pressed ground material derived from rigid PUR foam or semirigid PUR foam, Perlite, which is packed in a gastight film, evacuated and welded in so as to be airtight. The vacuum should be less than 100 mbar. Out of this vacuum, a thermal conductivity of the panels of, depending on the structure and pore size of the core material, less than 10 mW/mK can be achieved.

For thermal insulation purposes, the vacuum insulation panels are usually introduced into the component to be insulated and fixed there. The above-described components for thermal insulation usually comprise two compact layers, preferably metal sheets or polymers such as polystyrene.

In the production of refrigerators, the liquid rigid PUR foam reaction mixture is injected into a hollow space which is generally made up of metal outer walls, a rear wall composed of plastic or a multilayer composite based on cardboard and also a plastic inner housing (inliner). The VIPs have to be fixed in place before introduction of the reaction mixture in order to prevent uncontrolled movement of the elements during formation of the foam in the hollow space.

A customary method of fixing is the use of double-sided adhesive tape, with the VIPs being adhesively bonded either on the inside of the outer metal sheets (JP 2005-076966) or else on the inliner (EP-A-0434225). When the VIP has been fixed on the inside of the metal outer walls, the reacting rigid PUR foam reaction mixture flows around it during filling of the hollow space with foam. The heat of reaction evolved from the rigid PUR foam reaction mixture results in strong heating of the foam in the appliance. During subsequent cooling, undesirable deformation of the housing occurs due to different expansion coefficients of VIP and rigid PUR foam. The resulting varying deformation is especially noticeable on the side walls. This is, in particular, the case when using stainless steel surfaces and when using a double-sided adhesive tape for fixing the VIP, since in this case defects are particularly noticeable because of the shiny surface and a thin metal sheet is desired for cost reasons.

Adverse effects on the surface can be ruled out by using an additional strong sheet for stiffening. This solution is costly and complicated since no hollow spaces or the like are allowed to be formed when joining the metal sheets. A further disadvantage is that the weight of the refrigeration appliance is significantly increased.

DE-A 199 48 361 describes a method of fixing VIPs on the inliner of the housing and the door of a refrigeration appliance by means of an intermediate layer of a thermal insulation material. The intermediate layer can be a molding or a thermal insulation foam which is not specified in more detail but is applied in liquid form to the inliner and the VIP is placed thereon in this state. It is stated that thermal insulation foams are generally based on polyurethane.

EP-A 0 822 379 describes the fixing of VIPs on rigid plates by means of a rigid PUR foam reaction mixture which is customary in refrigeration appliance construction or preferably by means of a one-component PUR foam, e.g. Assil® from Henkel. The rigid plate is, for example, a metal plate or plastic plate, preferably a metal cassette. In one embodiment, the foam reaction mixture can firstly be applied to the plate and the VIP can be laid in the still liquid reaction mixture.

One-component PUR foams (e.g. Assil® from Henkel) typically have a free-foamed density of 20-30 g/l and are isocyanate prepolymers which comprise physical blowing agents under superatmospheric pressure. These systems have the disadvantage that they cure by means of atmospheric moisture and require a number of hours for this. Such a long curing time is uninteresting for refrigerator production for economic reasons since cycle times of a few minutes are usually achieved here.

Customary PUR foam reaction mixtures used in refrigeration appliance construction generally have free-foamed densities of from 25 to 45 g/l. In a corresponding example (EP-A 0 822 379), a cyclopentane-comprising PUR foam reaction mixture composed of a polyether polyol (OH number 400) and a polymeric diphenylmethane diisocyanate is used. According to the example, the formulation does not comprise any foam stabilizer. A disadvantage is that as a result the foam structure is not maintained but the foam instead collapses to a density of about 60 g/l (determined in accordance with DIN EN ISO 845). Owing to the extremely coarse-celled and open-pored foam structure, the foam surface obtained after bonding-on of the VIPs is characterized by great unevennesses, known as voids. These voids show up clearly on the outside through the thin metal outer wall and thus reduce the quality of the surface.

To ensure good distribution of the PUR foam reaction mixture over the area of an appliance wall under the VIP, the reaction mixture has to be introduced in a particular minimum weight per unit area (g/m²). In the case of the conventional systems having densities of from 25 to 45 g/l, satisfactory weights per unit area can be achieved only when high densifications (densification=density of the foamed molding/free-foamed bulk density) are employed. The use of high densifications means, however, that closed molds have to be used. In practice, a different specially closed mold would then have to be used for each cooling apparatus type. This leads to high production costs. In addition, high densifications, about >3, are difficult to achieve technically since pushing-out of the PUR foam formed becomes a problem.

WO 2005/026605 describes moldings of rigid compact polyurethane or a rigid polyurethane foam having a compact outer skin and a cellular core (=rigid polyurethane integral foam) comprising at least one vacuum insulation panel which are used for producing cooling apparatuses. The VIP is introduced into a mold in which the VIP is laid and the mold is then filled with the reaction mixture for the PUR foam. The mold is closed and the molding is taken out after the PUR foam has cured. The moldings are self-supporting, so that enclosure in metal or plastic housings, as in the case of conventional refrigerated containers, is not necessary. One of the sides of the molding can, however, be a layer of metal or plastic, with this layer also being placed in the mold.

The free-foamed density of the rigid polyurethane integral foam is from 200 to 800 kg/m³; that of the rigid compact polyurethane is in the range from 700 to 1200 kg/m³. The rigid compact polyurethane by definition does not comprise any blowing agent in the formulation. Owing to the compact outer skin, such systems have a higher lambda value than rigid PUR foams. Compact systems, too, have a high lambda value which is disadvantageous for the application.

A process for producing a composite composed of a vacuum insulation panel and an outer wall of a refrigeration appliance using a liquid PUR foam reaction mixture is described in DE 10 2008 026 528 A1. The PUR foam reaction mixture is applied as a curable bonding layer over the area of the inside of the outer wall of a cooling apparatus and/or to the outside of a wall of the inner container of a cooling apparatus and the VIP is laid therein. Foaming occurs in a closed mold until the reaction mixture has cured completely. It is stated that the foam system can be processed with an increased density. The PUR foam reaction mixture used is preferably a slow-blowing foam system which is characterized only by a fiber time of about 3 minutes.

It is an object of the invention to provide an improved PUR foam system for fixing VIPs in refrigeration appliances, which does not have the abovementioned disadvantages and at the same time has a satisfactory adhesion. In particular, a system which can also be used in a closure maintenance device, e.g. a press, should be provided.

It has surprisingly been found that the object can be achieved by use of the PUR foam reaction system according to claim 1.

The invention provides for the

Use of a polyurethane (PUR) foam reaction system comprising

a) organic and/or modified organic polyisocyanates together with

b) at least one relatively high molecular weight compound having at least two hydrogen atoms which are reactive toward isocyanate groups and optionally

c) low molecular weight chain extenders and/or crosslinkers in the presence of

d) blowing agents,

e) catalysts,

f) foam stabilizers and optionally

g) further auxiliaries and/or additives,

where the components a) to g) are selected so that a closed-cell polyurethane foam having a free-foamed density of from 50 to 1100 g/l and a compressive strength of greater than 15 kPa is obtained and rigid integral foams are excluded, for the fixing over an area of vacuum insulation panels (VIPs) on the inside of an outer wall of a cooling apparatus and/or on the outside of a wall of the inner container of a cooling apparatus.

The door of a cooling apparatus (e.g. a refrigerator) is also considered to be an outer wall of a cooling apparatus and the inliner of a door of a cooling apparatus is also considered to be a wall of the inner container.

The free-foamed density of the polyurethane foam used according to the invention is determined in accordance with DIN 53420 and is preferably from 55 to 500 g/l, in particular from 60 to 200 g/l.

The compressive strength of the foam is determined in accordance with DIN 53421. The polyurethane foam used according to the invention is accordingly a semirigid foam or a rigid foam.

The weight per unit area is the mass of material, i.e. the reaction mixture comprising the components a) to g), introduced per unit area. The weight per unit area of the polyurethane foam used according to the invention is from 300 to 9600 g/m², preferably from 330 to 6000 g/m², particularly preferably from 360 to 2400 g/m².

The polyurethane foam used according to the invention is closed-celled (DIN 7726); the proportion of open cells is not more than 15%.

For the purposes of the invention, a rigid polyurethane integral foam is a rigid polyurethane foam having a compact outer skin (largely cell-free) and a cellular core, i.e. the surface zone has a higher density than the core (DIN 7726).

Polyurethanes have been known for a long time and are widely described in the literature. They are usually produced by reacting polyisocyanates with compounds having at least two hydrogen atoms which are reactive toward isocyanate groups in the presence of blown agents, at least one catalyst and auxiliaries and/or additives.

The compounds having at least two hydrogen atoms which are reactive toward isocyanate groups are in most cases polyfunctional alcohols. Apart from polyester alcohols, polyether alcohols have the greatest industrial importance here.

The polyether alcohols are usually prepared by addition of alkylene oxides, preferably ethylene oxide and/or propylene oxide, onto polyfunctional alcohols and/or amines. The addition reaction is usually carried out in the presence of catalysts.

All these processes are known to those skilled in the art. A summary overview of the production of PUR foams has been, for example, published in Polyurethane, Kunststoff-Handbuch, volume 7, 1^{st} edition 1966, edited by Dr. R. Vieweg and Dr. A. Höchtlen, and 2^{nd} edition 1983, edited by Dr. Günter Oertel, Carl Hanser Verlag, Munich, Vienna.

As has been mentioned above, the PUR foams are produced by the process of the invention using the formative components known per se, about which the following details may be provided:

a) As organic isocyanates, it is possible to use all usual aliphatic, cycloaliphatic and preferably aromatic diisocyanates and/or polyisocyanates. As preferred isocyanates, it is possible to use tolylene diisocyanate (TDI) and/or diphenylmethane diisocyanate (MDI), preferably MDI, and particularly preferably mixtures of MDI and polymeric diphenylmethane diisocyanate (PMDI). These particularly preferred isocyanates can have been modified fully or partially with uretdione, carbamate, isocyanurate, carbodiimide, allophanate and preferably urethane groups.

Furthermore, prepolymers and mixtures of the above-described isocyanates and prepolymers can be used as isocyanate component. These prepolymers are prepared from the above-described isocyanates and the polyethers, polyesters or both described below and have an NCO content of usually from 14 to 32% by weight, preferably from 22 to 30% by weight.

b) As relatively high molecular weight compounds having groups which are reactive toward isocyanates, it is possible to use all compounds which have at least two groups which are reactive toward isocyanates, e.g. OH-, SH-, NH- and CH-acid groups. It is usual to use polyetherols and/or polyesterols having from 2 to 8, preferably from 2 to 6, hydrogen atoms which are reactive toward isocyanate. The OH number of these compounds is usually in the range from 30 to 850 mg KOH/g, preferably in the range from 100 to 500 mg KOH/g.

The polyetherols are obtained by known methods, for example by anionic polymerization of alkylene oxides with addition of at least one starter molecule comprising from 2 to 8, preferably from 2 to 6, reactive hydrogen atoms in bound form in the presence of catalysts. As catalysts, it is possible to use alkali metal hydroxides such as sodium hydroxide or potassium hydroxide or alkali metal alkoxides such as sodium methoxide, sodium or potassium ethoxide or potassium isopropoxide, or in the case of cationic polymerization Lewis acids such as antimony pentachloride, boron trifluoride etherate or bleaching earth as catalysts. Furthermore, double metal cyanide compounds, known as DMC catalysts, can also be used as catalysts.

Preference is given to using one or more compounds having from 2 to 4 carbon atoms in the alkylene radical, e.g. ethylene oxide, 1,2-propylene oxide, tetrahydrofuran, 1,3-propylene oxide, 1,2- or 2,3-butylene oxide, in each case either alone or in the form of mixtures, particularly preferably ethylene oxide and/or 1,2-propylene oxide, as alkylene oxides.

Possible starter molecules are, for example, ethylene glycol, diethylene glycol, glycerol, trimethylolpropane, pentaerythritol, sugar derivatives such as sucrose, hexitol derivatives such as sorbitol, also methylamine, ethylamine, isopropylamine, butylamine, benzylamine, aniline, toluidine, toluenediamine, in particular vicinal toluenediamine, naphthylamine, ethylenediamine, diethylenetriamine, 4,4′-methylenedianiline, 1,3,-propanediamine, 1,6-hexanediamine, ethanolamine, diethanolamine, triethanolamine and other dihydric or polyhydric alcohols or monofunctional or polyfunctional amines. Preference is given to ethylene glycol, diethylene glycol, glycerol, trimethylolpropane, pentaerythritol, sugar derivatives such as sucrose and hexitol derivatives such as sorbitol.

The polyester alcohols used are usually prepared by condensation of polyfunctional alcohols having from 2 to 12 carbon atoms, e.g. ethylene glycol, diethylene glycol, butanediol, trimethylolpropane, glycerol or pentaerythritol, with polyfunctional carboxylic acids having from 2 to 12 carbon atoms, for example succinic acid, glutaric acid, adipic acid, suberic acid, azelaic acid, sebacic acid, decanedicarboxylic acid, maleic acid, fumaric acid, phthalic acid, isophthalic acid, terephthalic acid, the isomers of naphthalenedicarboxylic acids or the anhydrides of the acids mentioned.

As further starting materials in the preparation of the polyesters, it is also possible to make concomitant use of hydrophobic materials. The hydrophobic materials are water-insoluble materials which comprise a nonpolar organic radical and have at least one reactive group selected from among hydroxyl, carboxylic acid, carboxylic ester or mixtures thereof. The equivalent weight of the hydrophobic materials is preferably in the range from 130 to 1000 g/mol. It is possible to use, for example, fatty acids such as stearic acid, oleic acid, palmitic acid, lauric acid or linoleic acid and also fats and oils such as castor oil, maize oil, sunflower oil, soybean oil, coconut oil, olive oil or tall oil.

The polyesterols used preferably have a functionality of from 1.5 to 5, particularly preferably from 1.8 to 3.5.

c) The compound having groups which are reactive toward isocyanates further comprises chain extenders and/or crosslinkers. As chain extenders and/or crosslinkers, it is possible to use, in particular, bifunctional or trifunctional amines and alcohols, in particular diols, triols or both, in each case having molecular weights of less than 350 g/mol, preferably from 60 to 300 g/mol and in particular from 60 to 250 g/mol. Bifunctional compounds of this type are referred to as chain extenders and trifunctional or higher-functional compounds are referred to as crosslinkers. Possibilities are, for example, aliphatic, cycloaliphatic and/or aromatic diols having from 2 to 14, preferably from 2 to 10, carbon atoms, e.g. ethylene glycol, 1,2-, 1,3-propanediol, 1,2-, 1,3-pentanediol, 1,10-decanediol, 1,2-, 1,3-, 1,4-dihydroxycyclohexane, diethylene glycol and triethylene glycol, dipropylene glycol and tripropylene glycol, 1,4-butanediol, 1,6-hexanediol and bis(2-hydroxyethyl)hydroquinone, triols such as 1,2,4-, 1,3,5-trihydroxycyclohexane, glycerol and trimethylolpropane and low molecular weight hydroxyl-comprising polyalkylene oxides based on ethylene oxide and/or 1,2-propylene oxide and the abovementioned diols and/or triols as starter molecules.

If isocyanate prepolymers are used as isocyanates (a), the content of compounds (b) having groups which are reactive toward isocyanates is calculated with inclusion of the compounds (b) having groups which are reactive toward isocyanates used for preparing the isocyanate prepolymers.

As blowing agent (d), a blowing agent comprising water is used. Here, water can be used either alone or in combination with further blowing agents. The content of water in the blowing agent (d) is preferably greater than 40% by weight, particularly preferably greater than 60% by weight and very particularly preferably greater than 80% by weight, based on the total weight of the blowing agent (d). In particular, water is used as sole blowing agent. If further blowing agents apart from water are used, it is possible to use, for example, chlorofluorocarbons, saturated and unsaturated fluorinated hydrocarbons, hydrocarbons, acids and/or liquid or dissolved carbon dioxide. Unsaturated fluorinated hydrocarbons are also referred to as HFOs, or hydrofluoroolefin. In a further embodiment, a mixture of water and formic acid and/or carbon dioxide can be used as blowing agent (d). To be able to disperse the blowing agent in the polyol component more easily, the blowing agent (d) can be mixed with polar compounds such as dipropylene glycol.

The water content, based on the total weight of the components (b) to (f), is from 0.05 to 3% by weight, particularly preferably from 0.1 to 2% by weight.

As catalysts (e), it is possible to use all compounds which accelerate the isocyanate-water reaction or the isocyanate-polyol reaction. Such compounds are known and are described, for example, in “Kunststoffhandbuch, volume 7, Polyurethane”, Carl Hanser Verlag, 3^{rd} edition 1993, chapter 3.4.1. These include amine-based catalysts and catalysts based on organic metal compounds.

As catalysts based on organic metal compounds, it is possible to use, for example, organic tin compounds such as tin(II) salts of organic carboxylic acids, e.g. tin(II) acetate, tin(II) octoate, tin(II) ethylhexanoate and tin(II) laurate, and the dialkyltin(IV) salts of organic carboxylic acids, e.g. dibutyltin diacetate, dibutyltin dilaurate, dibutyltin maleate and dioctyltin diacetate, and also bismuth carboxylates such as bismuth(III) neodecanoate, bismuth 2-ethylhexanoate and bismuth octanoate or alkali metal salts of carboxylic acids, e.g. potassium acetate or potassium formate.

Preference is given to using a mixture comprising at least one tertiary amine as catalyst (e). These tertiary amines are usually compounds which can also bear groups which are reactive toward isocyanate, e.g. OH, NH or NH₂ groups. Some of the most frequently used catalysts are bis(2-dimethylaminoethyl) ether, N,N,N,N,N-pentamethyldiethylenetriamine, N,N,N-triethylaminoethoxyethanol, dimethylcyclohexylamine, dimethylbenzylamine, triethylamine, triethylenediamine, pentamethyldipropylenetriamine, dimethylethanolamine, N-methylimidazole, N-ethylimidazole, tetramethylhexamethylenediamine, tris(dimethylaminopropyl)hexahydrotriazine, dimethylaminopropylamine, N-ethylmorpholine, diazabicycloundecene and diazabicyclononene. Preference is given to using mixtures comprising at least two different tertiary amines as catalysts (e).

Foam stabilizers (f) are materials which promote formation of a regular cell structure during foaming. Examples are: silicone-comprising foam stabilizers such as siloxaneoxalkylene copolymers and other organopolysiloxanes. Also alkoxylation products of fatty alcohols, oxo alcohols, fatty amines, alkylphenols, dialkylphenols, alkylcresoles, alkylresorcinol, naphthol, alkylnaphthol, naphthylamine, aniline, alkylaniline, toluidine, bisphenol A, alkylated bisphenol A, polyvinyl alcohol and also alkoxylation products of condensation products of formaldehyde and alkylphenols, formaldehyde and dialkylphenols, formaldehyde and alkylcresoles, formaldehyde and alkylresorcinol, formaldehyde and aniline, formaldehyde and toluidine, formaldehyde and naphthol, formaldehyde and alkylnaphthol and also formaldehyde and bisphenol A or mixtures of two or more of these foam stabilizers.

Foam stabilizers are preferably used in an amount of from 0.5 to 4% by weight, particularly preferably from 1 to 3% by weight, based on the total weight of the components (b) to (e).

As further additives (g), it is possible to use fillers and other additives such as antioxidants.

Fillers, in particular reinforcing fillers, are the customary organic and inorganic fillers, reinforcing materials, etc., known per se. Specific examples are: inorganic fillers such as siliceous minerals, for example sheet silicates such as antigorite, serpentine, hornblendes, amphiboles, chrysotile, talc; metal oxides such as kaolin, aluminum oxides, titanium oxides and iron oxides, metal salts such as chalk, barite and inorganic pigments such as cadmium sulfide, zinc sulfide and also glass and others. Preference is given to using kaolin (China clay), aluminum silicate and coprecipitates of barium sulfate and aluminum silicate and also natural and synthetic fibrous minerals such as wollastonite, metal fibers and in particular glass fibers of various lengths, which may optionally be coated with a size. It is also possible to use hollow glass microspheres.

Possible organic fillers are, for example: carbon, melamine, rosin, cyclopentadienyl resins and graft polymers and also cellulose fibers, polyamide, polyacrylonitrile, polyurethane, polyester fibers based on aromatic and/or aliphatic dicarboxylic esters and carbon fibers.

The vacuum insulation panels (VIPs) used according to the invention generally comprise a thermally insulating core material, for example open-celled rigid polyurethane (PUR) foam, open-celled extruded polystyrene foam, silica gels, glass fibers, beds of polymer material, pressed ground material derived from rigid PUR foam or semirigid PUR foam, Perlite, which is packed in a gastight film, evacuated and welded in so as to be airtight. The vacuum should be less than 100 mbar. At this vacuum, it is possible to achieve a thermal conductivity of the panels of, depending on the structure and pore size of the core material, less than 10 mW/mK.

For the purposes of the invention, cooling apparatuses are, inter alia, refrigeration appliance housings (e.g. of refrigerators), containers for refrigerated vehicles, coolboxes, cooling cells or district heating pipes.

The invention further provides a process for producing composites which comprise a wall of a cooling apparatus, a PUR foam layer and at least one VIP. The wall of the cooling apparatus is either the inside of the outer wall of a cooling apparatus or the outside of a wall of the inner container. The door of a cooling apparatus (e.g. of a refrigerator) is also considered to be an outer wall of a cooling apparatus and the inliner of a door of a cooling apparatus is also considered to be a wall of the inner container.

The outer wall is usually made of metal, while the inner container and linings are generally and in particular in the case of refrigerators made of a polymer material.

The process of the invention is defined in the claims.

A layer thickness of the PUR foam used according to the invention as fixing agent of from 2 to 30 mm can be set by means of a holding device in which the distance between the lower boundary and the upper boundary can be varied at will. The lower boundary of the holding device is a flat surface.

According to a preferred embodiment, the holding device is a press. The upper boundary in this case acts as counterweight. The counterweight can be shifted in a defined manner in order to set a particular spacing. In this preferred device, the assembly is open at the sides.

The wall of the cooling apparatus is placed on the lower boundary of the holding device. If desired, a mold frame which bounds the area to be filled on the inside can additionally be used. The liquid PUR reaction mixture to be used according to the invention is then applied (optionally in the mold frame) over an area to the wall of the cooling apparatus, with a weight per unit area of from 300 to 9600 g/m² having been found to be advantageous. At least one VIP is placed on the still liquid reaction mixture and the layer thickness of the PUR foam is set as described above. After sufficient curing of the PUR foam reaction mixture, the composite produced by the process of the invention is taken out.

The VIP can in principle cover the entire area. In this case, surface effects as described above do not play any great role. When the VIP does not cover the entire surface, there are in principle two possibilities: 1. a space reserver having the same height as the VIP is inserted and is removed again after fixing of the VIP by means of the PUR reaction mixture. 2. without space reserver, the rising foam will fill the remaining hollow space which is not occupied by the VIP.

The process of the invention can be repeated on further walls of the cooling apparatus.

In another embodiment, the production of the composites can also be carried out in a mold closed all around, as is customary in refrigerator construction. This variant is preferred when the VIP is applied to the outer wall of the inner housing of the cooling apparatus or on the inliner of the door of the cooling apparatus.

To produce corresponding doors, the inliner is placed in a closed mold, the PU foam reaction system used according to the invention is applied, at least one VIP is placed on top; the inside of a metal door is placed on top and the mold is closed.

The cooling apparatuses can be manufactured by fixing the composites of metal outer wall, PUR foam layer and VIP produced according to the invention to an inliner of the housing of a cooling apparatus and the remaining hollow space of the cooling apparatus is filled with a conventional rigid PUR foam as is customary for insulating cooling apparatuses (e.g. Elastocool® from BASF, WO 2006/037540, free-foamed density from 25 to 45 g/l).

As an alternative, the cooling apparatuses can be manufactured by fastening metal outer walls on the outer wall of a composite of housing inliner, PUR foam layer and VIP produced as described above and filling the remaining hollow space of the cooling apparatus with a conventional rigid PUR foam as described above.

### EXAMPLES

TABLE 1
Polyols used:

| | | Hydroxyl | |
|---|---|---|---|
| | | number | |
| Polyol | Chemical composition | mg KOH/g | Functionality |
| 1 | Glycerol-propylene oxide (PO) | 400 | 3.0 |
| 2 | Sucrose/pentaerythritol/diethylene | 400 | 3.9 |
| | glycol-PO | | |
| 3 | Monopropylene glycol-PO | 100 | 2.0 |
| 4 | Sucrose/glycerol-PO | 450 | 5.0 |
| 5 | Toluenediamine (TDA)-ethylene | 390 | 3.8 |
| | oxide (EO)/PO | | |
| 6 | TDA-EO/PO | 160 | 3.9 |

### Example 1

### Production of the PUR Foam from A and B Component for Fixing the VIP

A Component:

Mixture of 22 parts by weight of polyol 1, 48.65 parts by weight of polyol 2, 22 parts by weight of polyol 3 together with 3 parts by weight of propylene carbonate, 0.55 part by weight of water, 1 part by weight of a foam stabilizer (Niax Silicon L6900), 0.7 part by weight of N,N-dimethylcyclohexylamine and 1.8 parts by weight of dimethylbenzylamine

B Component: Polymeric MDI (Lupranat® M20 from BASF SE)

The foam was produced from A and B components at a mixing ratio of A component to B component of 100:88. The starting materials were mixed manually. The fiber time was 127 s. This gave a uniform PUR foam having a free-foamed density of 140 g/l. The mixing ratio describes the mass ratio of the component A to the component B.

Determination of the Weight Per Unit Area

The mixture of A and B components was introduced as quickly as possible into a mold having the following internal dimensions: 400 mm×300 mm×10 mm. It was introduced over the entire length of the mold in the middle of the mold. The mold was subsequently closed firmly. The foam specimen was taken after 10 minutes. The results for the respective specimens are summarized in table 2.

### Example 2

### Production of the Rigid PUR Foam

A Component:

Analogous to example 1 but with 1.8 parts by weight of water, 1.2 parts by weight of N,N-dimethylcyclohexylamine and 2.0 parts by weight of dimethylbenzylamine

B component: Polymeric MDI (Lupranat® M20 from BASF SE)

The foam was produced from A and B components at a mixing ratio of A component to B component of 100:105. The starting materials were mixed manually. The fiber time was 90 s.

This gave a uniform PUR foam having a free-foamed density of 55 g/l. The weight per unit area was determined by a method analogous to example 1.

### Example 3

### Comparative Example Analogous to EP 0822379 Production of the Rigid PUR Foam

A Component:

Mixture of 100 parts by weight of polyol 4 together with 2 parts by weight of water, 10 parts by weight of cyclopentane 95 and 2.0 parts by weight of N,N-dimethylcyclohexylamine

B Component: Polymeric MDI (Lupranat® M20 from BASF SE)

The foam was produced in a manner analogous to the patent EP 0 822 379 by reacting 100 parts by weight of polyol 4 (A component) with 100 parts by weight of B component. The starting materials were mixed manually. The fiber time was 90 s.

This gave a nonuniform rigid PUR foam having cells of significantly different sizes and a free-foamed density of 63 g/l (determined in accordance with DIN EN IS0845). The foam had a proportion of open cells of 67% (determined in accordance with DIN ISO 4590) and a very poor surface characterized by large voids.

The weight per unit area was determined by a method analogous to example 1.

TABLE 2
Summary of the results

| | Free- | | Average | Weight |
|---|---|---|---|---|
| | foamed | | density of | per unit |
| | density | | the molding | area |
| Example | g/l | Densification | g/l | g/m² |
| 1 | 140 | 1.3 | 179 | 1867 |
| 2 | 55 | 1.5 | 82 | 883 |
| 3 | 63 | Not able to be | Not able to be | Not able to be |
| | | determined* | determined* | determined* |

*Determination is not possible because of collapse of the PUR foam, as a result of which complete filling of the volume to be filled was not possible, regardless of the densification, i.e. even at densifications of >2.5.

Experimental Setup for Production According to the Invention of Composites Comprising VIPs

Composites comprising a metallic outer wall of a cooling apparatus, a PUR foam layer as described in examples 1 to 3 and VIP were produced. An open press in which the distance between lower boundary (flat surface) and upper boundary (counterweight) can be varied at will was used for producing the composites.

The metal outer wall of a cooling apparatus was laid on the lower boundary of the press. On the inside thereof, the liquid PUR foam reaction mixture as described in examples 1 to 3 was applied uniformly over the area as fixing agent. A silica VIP from va-Q-tec (dimensions: 800×430×15 mm) was laid on the still liquid reaction mixture and the layer thickness of the PUR foam was set to 5 mm by means of the upper boundary of the apparatus. After curing of the PUR foam reaction mixture, the composite of metal outer wall, PUR foam layer and VIP was taken out.

The procedure was repeated for the second outer side and the refrigeration appliance. The composites produced in this way as side walls and a conventional rear wall were then fastened to a polystyrene inner housing to construct a refrigerator housing and the hollow space then remaining in the refrigerator was filled with Elastocool® foam. After production of the appliances, these were stored for a few days and subsequently evaluated.

It was found that when PUR foam reaction mixtures as described in examples 1 and 2 according to the process of the invention are used, it is possible to produce composites which are stable and result in no or visually barely perceptible deformations or other adverse effects on the outer walls of the refrigeration appliances.

When the PUR reaction system as described in example 3 was used, severe pushing-out of the foam at the sides of the press occurred. As a result, the composites could not be used for constructing a refrigerator housing. When a closed mold was used, the pushing-out could be prevented. However, high densifications, i.e. >1.8, were necessary to achieve complete filling of the area under the VIP.

1. The use of a polyurethane (PUR) foam reaction system comprising
a) organic and/or modified organic polyisocyanates together with
b) at least one relatively high molecular weight compound having at least two hydrogen atoms which are reactive toward isocyanate groups and optionally
c) low molecular weight chain extenders and/or crosslinkers in the presence of
d) blowing agents,
e) catalysts,
f) foam stabilizers and optionally
g) further auxiliaries and/or additives,
where the components a) to g) are selected so that a closed-cell polyurethane foam having a free-foamed density of from 50 to 1100 g/l and a compressive strength of greater than 15 kPa is obtained and rigid integral foams are excluded, for the fixing over an area of vacuum insulation panels (VIPs) on the inside of an outer wall of a cooling apparatus and/or on the outside of a wall of the inner container of a cooling apparatus.

2. The use according to claim 1, wherein water is used as sole blowing agent d).

3. The use according to claim 2, wherein the water content, based on the components b) to g), is from 0.05 to 3% by weight.

4. The use according to any of claims 1 to 3, wherein the free-foamed density of the polyurethane foam is from 55 to 500 g/l.

5. The use according to any of claims 1 to 4, wherein the free-foamed density of the polyurethane foam is from 60 to 200 g/l.

6. A process for producing composites comprising a wall of a cooling apparatus, a PU foam layer and at least one VIP, which comprises the following steps:
1) laying of an outer wall or a wall of the inner container of a cooling apparatus on the lower flat boundary of a holding device in which the distance between lower boundary and upper boundary can be varied,
2) application of a liquid PU foam reaction system comprising
a) organic and/or modified organic polyisocyanates together with
b) at least one relatively high molecular weight compound having at least two hydrogen atoms which are reactive toward isocyanate groups and optionally
c) low molecular weight chain extenders and/or crosslinkers in the presence of
d) blowing agents,
e) catalysts,
f) foam stabilizers and optionally
g) further auxiliaries and/or additives,
where the components a) to g) are selected so that a polyurethane foam having a free-foamed density of from 50 to 1100 g/l and a compressive strength of greater than 15 kPa is obtained and rigid integral foams are excluded;
over all or part of the area of the inside of the outer wall of the cooling apparatus or the outside of a wall of the inner container of the cooling apparatus in a weight per unit area of 300-9600 g/m²;
3) laying of at least one vacuum insulation panel (VIP) on the liquid PU foam reaction mixture,
4) closing of the holding device and
5) removal of the composite from the holding device after sufficient curing of the PU foam reaction mixture.

7. The process according to claim 6, wherein the holding device is a press.

8. The process according to claim 6 or 7, wherein water is used as sole blowing agent d).

9. The process according to claim 8, wherein the water content, based on the components b) to g), is from 0.05 to 3% by weight.

10. The process according to any of claims 6 to 9, wherein the free-foamed density of the polyurethane foam is from 55 to 500 g/l.

11. The process according to any of claims 6 to 10, wherein the free-foamed density of the polyurethane foam is from 60 to 200 g/l.
